(19) United States
(12) Patent Application Publication
(10) Pub. No.: US 2011/0183278 A1
(43) Pub. Date: Jul. 28, 2011

(54) Combustion Tool Comprising a Quarl Block and an Injector, Assembly of Said Tool and Furnace Equipped with Said Tool

(75) Inventors: Brenice Belasse, Maintenon (FR); Robert Kalcevic, Versailles (FR); Chendhil Periasamy, Newark, DE (US); Rajeev S. Prabhakar, Wilmington, DE (US)

(73) Assignee: L'Air Liquide Societe Anonyme Pour L'Etude Et L'Exploitation Des Procedes Georges Claude, Paris (FR)

(21) Appl. No.: 12/936,154

(22) PCT Filed: Feb. 25, 2009
(86) PCT No.: PCT/FR2009/050298

§ 371 Date: Mar. 22, 2011

(30) Foreign Application Priority Data
Apr. 3, 2008 (FR) 0852238

(51) Int. Cl. F23D 14/62; B23P 11/00

(52) U.S. Cl. 431/354; 29/428

(57) ABSTRACT

The invention relates to a combustion tool including a quarl block made of refractory material, the quarl block defining a quarl exit and a passage between the entry surface and quarl block, said tool including an injector of oxidizer and/or fuel that extends through the passage and opens into the quarl block, and also including a sheath that surrounds the injector in the passage section.

The present invention relates to a combustion tool, such as a burner comprising a quarl block and at least one injector, and to the assembly of such a combustion tool that can be used in a furnace containing an atmosphere rich in volatiles and/or in suspended matter.

In the present context, the term “combustion tool” is understood to mean a tool for conveying a fuel and/or an oxidant from the outside into a combustion chamber via a body made up of pipes or parts generally made of metal. At the end of this body there are one or more injectors, the purpose of which is, on the one hand, to join up with the quarl block and, on the other hand, to transmit, to the fuel and/or oxidant jet(s), the aerodynamic characteristics necessary for obtaining a flame with the desired specificities.

The term “burner” is understood to mean a “combustion tool” used for conveying and combining fuel and oxidant.

The injectors are generally also made of metallic materials, firstly because of the constraints in terms of precision and of connection to the metal body and, secondly, in terms of cost, because refractory ceramic parts are expensive.

The term “refractory” in the case of nonmetallic materials characterizes those nonmetallic materials that can be used at temperatures above or at least equal to 1500° C.

The quarl block is generally made of one or more nonmetallic refractory materials. Its function is to protect the metal parts of the combustion tool or of the burner from the radiation coming from the combustion chamber and also to make the join between the tool or the burner and the wall of the enclosure in which the flame develops, this enclosure being called hereafter “combustion chamber”.

Such a burner and its use in a glass conditioning feeder are known in particular from WO 99/39833.

The use of one or more injectors in heating processes often imposes constraints on the maintenance or replacement of said injectors.

This is because, when the tool or burner is being used:

the temperature at the outlet of the quarl block is generally very close to that inside the combustion chamber; and

the temperature of the injector(s) is generally below that of the quarl block and, a fortiori, also below the maximum operating temperature of the material of which the injector(s) is (are) composed. This temperature is lower than that of the quarl block owing to the fluids, whether gases or liquids, flowing in the injector(s).

The flow of fluids in the injector therefore cools said injector so as to maintain its temperature below a limit threshold imposed by the characteristics of the material of which it is composed. The consequence of insufficient cooling is the relatively rapid degradation/deterioration of the material and therefore of the injection, for example the oxidation or melting of the material. Insufficient cooling of the injector may also have the effect of forming soot, resulting in carbon being deposited on the injector and obstructing the fluid outlet zone, especially if it is a fuel, because of initiation of the combustion or decomposition reaction in said outlet zone. The cooling of the injector by the flow of injected fluid(s) thus protects the injector.

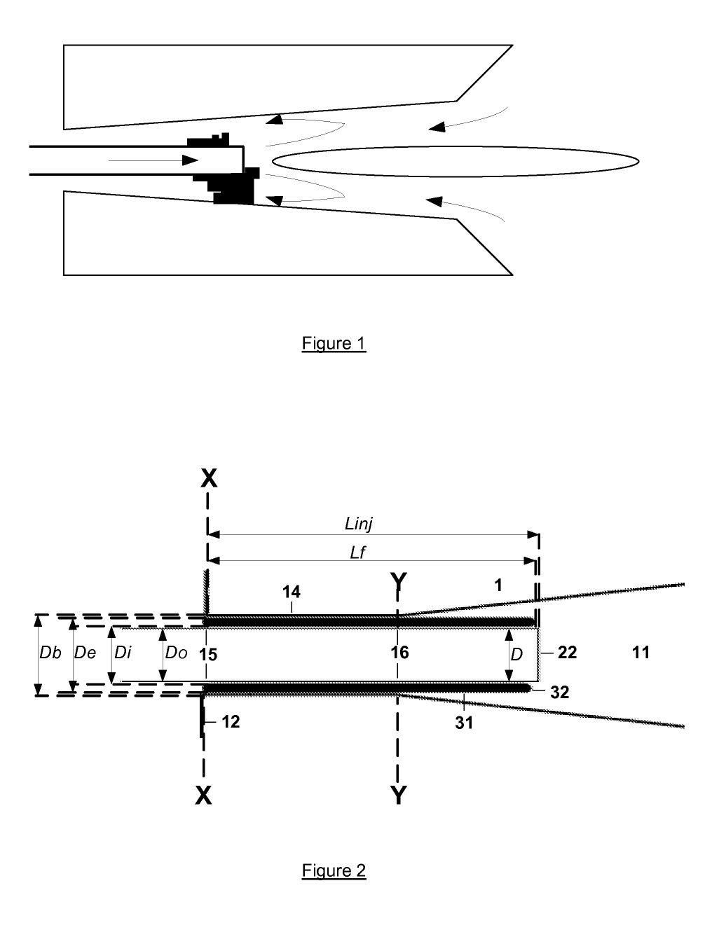

However, injector cooling may also cause problems, such as for example, in particular, the appearance of a deposit of material on the tip of the injector. This deposit comes from the volatile materials or other suspended matter often present in the atmosphere of the combustion chamber and/or of the quarl block and getting into the injector, aided in particular by the effects of combustion gas recirculation close to the injector (as illustrated in FIG. 1).

Specifically, since the temperature of the injector is lower than that of the quarl block and a fortiori also lower than that in the combustion chamber, the volatile materials have a tendency to condense on the cooler wall of the injector. This condensation results in a deposit of material that may not only encroach on the zone close to the fluid outlet, to the point of impeding or even preventing correct injection of the fluid, but also encroach on the quarl block with the risk of damaging it and/or making it difficult or even impossible to remove the injector from the quarl block for carrying out maintenance thereon or for replacing it.

This condensation phenomenon arises especially in melting furnaces, such as glass melting furnaces, and has in particular been observed in furnace feeders (also called forehearths) for conditioning the glass such as, for example, in the case of glass fiber manufacturing processes.

Deposits have in fact been found on the injectors of burners. Analyses of these deposits have shown that they comprise, on the one hand, molten glass on the injector close to its end and, on the other hand, sulfur-containing elements upstream of the end of the injector.

Over and above the additional maintenance costs incurred by this condensation phenomenon, the risk of damaging the injector and/or the quarl block is significantly increased. This may entail replacing this equipment more frequently and a fortiori may incur a financial overcost, which may be substantial, especially in the case of glass conditioning where the number of tools or burners used may approach several hundred.

The object of the present invention is to reduce, or even eliminate, this phenomenon of volatile materials or suspended matter condensing on the injectors fitted into a quarl block.

The present invention relates in particular to a combustion tool comprising a quarl block and an injector, which tool may in particular be a burner.

The quarl block is a block made of nonmetallic refractory material. It has an entry face for a fuel and/or an oxidant and an exit face opposite the entry face. The block defines a quarl exit that opens onto the exit face and a duct between the entry face and the quarl exit. The duct has a substantially annular or cylindrical output section with an inlet that is located in or directed toward the entry face and, opposite the inlet, an outlet that opens into the quarl exit.

The injector is used to convey fuel and/or oxidant from the entry face of the block toward the quarl exit. The injector passes through the duct and has a tip that terminates in an injection opening that opens into the quarl exit.

According to the invention, the combustion tool also includes a sheath comprising a substantially cylindrical sleeve that surrounds the injector at least in the output section of the duct. The sheath has a downstream end that opens into the quarl exit.

According to the invention, the block, the injector and the sleeve of the sheath are such that:

1) the difference Db−De between, on the one hand, the inside diameter Db of the output section of the duct and, on the other hand, the outside diameter De of the substantially cylindrical sleeve of the sheath is greater than or equal to 0.4 mm and less than or equal to 1.0 mm (0.4 mm≦Db−De≦1.0 mm);

2) there is a clearance ΔD of 0.2 mm to 0.4 mm between the substantially cylindrical sleeve of the sheath and the injector; and

3) the length Lf of the substantially cylindrical sleeve of the sheath between the inlet of the output section of the duct and the downstream end of the sheath is less than or equal to the length Linj of the injector between the inlet of the output section of the duct and the injection opening of the injector, but greater than or equal to 0.8 times this length Linj of the injector (0.8×Linj≦Lf≦Linj), preferably 0.9×Linj≦Lf≦Linj.

The quarl block is typically made of ceramic refractory material. The quarl block may consist of a single part made of nonmetallic refractory material or may consist of several parts.

Advantageously, the output section of the duct is substantially cylindrical.

In general, the injector is a metallic injector. Its geometry is generally substantially cylindrical.

The injector may be a one-pipe injector comprising a single fuel and/or oxidant injection pipe or a multi-pipe injector comprising several injection pipes, such as a “pipe-in-pipe” injector.

In the case of a multi-pipe injector, the sleeve of the sheath surrounds the external injection pipe of the injector, at least in the output section of the duct.

The length Lf of the sleeve of the sheath is advantageously equal to the length Linj of the injector.

When the combustion tool or the burner comprises several fuel and/or oxidant injectors and corresponding ducts, several of said ducts, or all of said ducts, may be equipped with a sheath and with an injector in the manner described below.

Between the substantially cylindrical sleeve of the sheath and the injector, the internal surface of the sleeve or the external surface of the injector is usefully provided with projecting support/centering zones that support and center the injector inside the sleeve, thus limiting direct contact between the sleeve and the injector.

Thus, when the internal surface of the substantially cylindrical sleeve of the sheath is provided with support/centering zones projecting between the substantially cylindrical sleeve and the injector, said support/centering zones advantageously cover less than 20%, preferably less than 15% and even more preferably less than 10% of the internal area of the sleeve.

Similarly, when the external surface of the injector is provided with support/centering zones projecting between the injector and the sleeve, said zones cover less than 20%, preferably less than 15% and even more preferably less than 10% of the external area of the injector.

In practice, it is preferable for the support/centering zones to be located on the external surface of the injector.

The support/centering zones may have different shapes. For example, they may be projecting annular zones, the axis of which coincides with the axis of the substantially cylindrical sleeve or of the injector. The support zones may also take the form of gable walls or any other suitable shape for supporting and centering the injector inside the sleeve of the sheath.

The support/centering zones preferably have a thickness d of 1.0 mm to 4.0 mm, preferably 2.0 mm to 3.0 mm, the thickness being measured along the radial direction relative to the longitudinal axis of the sleeve/of the injector. It should be noted that the thickness of the support/centering zones does not form part of the clearance ΔD between the sleeve and the injector.

The sleeve may be a steel sleeve.

The sleeve must withstand high temperatures, typically around 300 K below the temperature in the combustion chamber.

Consequently, the sleeve is advantageously made of a refractory ceramic or a refractory metal.

The term “refractory” in the case of metals characterizes those metals that can be used at temperatures above or at least equal to 900° C.

A refractory steel sleeve is preferred.

Advantageously, the expansion coefficient Cdinj of the injector is close to the expansion coefficient Cdf of the sleeve of the sheath. Thus, it is desirable that 0.80×Cdf≦Cdinj≦1.05×Cdf, preferably 0.80×Cdf≦Cdinj≦Cdf and more preferably 0.90×Cdf≦Cdinj≦Cdf.

Preferably, the sleeve also includes one or more anchoring elements fixing the position of the sleeve relative to the inlet of the output section of the duct.

For example, the sleeve may comprise a flange that bears on, or fins that bear on, the entry face of the quarl block, in particular when the inlet of the output section is located in this face.

The duct of the quarl block may also have a second section upstream of the output section and with a larger diameter than this output section, so that the inlet of the output section lies between this larger-diameter second section and the substantially annular or cylindrical output section of the duct. In this case, the sheath may be anchored in a part of the sheath which is located upstream of the sleeve and which fits into this second section of the duct, located upstream of the output section of the duct. The sheath then typically includes a part located upstream of the sleeve, the outside diameter of which is larger than the diameter of the sleeve.

The invention also relates to a furnace having walls around a combustion chamber, said furnace comprising at least one combustion tool or in particular at least one burner according to any of the embodiments described above, this at least one combustion tool or burner being fitted into at least one of said walls in such a way that the quarl exit opens into the combustion chamber. The combustion tool or burner according to the invention is typically mounted in a furnace wall made of refractory material.

In particular, the furnace may be a glass melting furnace or a glass conditioning feeder. The combustion tool or burner may especially be mounted in a glass melting furnace or in a glass conditioning feeder for glass fiber manufacture.

The invention also relates to a method for assembling a combustion tool, such as a burner. Said combustion tool or burner includes a fuel and/or oxidant injector having a tip that terminates in an injection opening. The tool is fitted into a quarl block made of nonmetallic refractory material having an entry face for a fuel and/or an oxidant and an exit face opposite the entry face, said quarl block defining a quarl exit that opens onto the exit face, and a duct between the entry face and the quarl exit, said duct having a substantially annular or cylindrical output section with an inlet in or directed toward the entry face and, opposite the inlet, an outlet that opens into the quarl exit.

According to the invention, a sheath comprising a substantially cylindrical sleeve having a downstream end is fitted into the duct of the block so that the substantially cylindrical sleeve of the sheath enters the output section of the duct and the downstream end of the sleeve opens into the quarl exit.

The injector is therefore fitted into the duct of the quarl block so that:

1) the injector runs along the passage;

2) the injection opening opens into the quarl exit; and

3) the sleeve of the sheath surrounds the injector, at least in the output section of the duct.

As already mentioned above in relation to the tool according to the invention, the burner is assembled in such a way that:

1) 0.4 mm≦Db−De≦1.0 mm;

2) there is a clearance ΔD of 0.2 mm to 0.4 mm between the substantially cylindrical sleeve of the sheath and the injector; and

3) 0.8×Linj≦Lf≦Linj, preferably 0.9×Linj≦Lf≦Linj.

Typically, the quarl block is made of refractory ceramic.

Advantageously, the output section of the duct is substantially cylindrical.

Generally, the injector is made of metal.

Advantageously, the length Lf of the sleeve of the sheath is substantially equal to the length Linj of the injector.

To allow the tool to operate, the injector is connected, depending on the case, either to a fuel supply or to an oxidant supply, or else, when the injector is intended to inject both fuel and oxidant, to an oxidant supply and to a fuel supply. This connection is typically made after the injector has been mounted in the duct, as described above.

According to the invention, the tool may be assembled when the quarl block is mounted in a wall of a furnace combustion chamber.

The quarl block may especially be located in a wall of a glass melting furnace and especially in a wall of a glass conditioning feeder.

The method of assembly thus makes it possible to convert a pre-existing tool, such as a burner, of a combustion chamber/of a furnace without a sheath as described above, and is therefore liable to have a problem of deposition on the injector, into a tool or burner according to the invention without it being necessary to modify or to replace the quarl block in the wall.

As already indicated, the internal surface of the substantially cylindrical sleeve of the sheath may be provided with support/centering zones projecting between the substantially cylindrical sleeve and the injector. In this case, said support/centering zones advantageously cover less than 20%, preferably less than 15% and even more preferably less than 10% of the internal area of the substantially cylindrical sleeve.

More advantageously, the external surface of the injector is provided with support/centering zones projecting between the injector and the substantially cylindrical sleeve, said support/centering zones covering more particularly less than 20%, preferably less than 15% and even more preferably less than 10% of the external area of the injector.

Advantageously, the support/centering zones have a thickness d of 1.0 mm to 4.0 mm, preferably typically 2.0 mm to 3.0 mm.

The sleeve may be made of steel, refractory ceramic or refractory metal. A refractory steel sleeve is preferred.

The material of the sheath is usefully chosen such that 0.80×Cdf≦Cdinj≦1.05×Cdf, preferably 0.80×Cdf≦Cdinj≦Cdf and more preferably 0.90×Cdf≦Cdinj≦Cdf.

As described above, the sheath may be equipped with anchoring elements.

The invention also relates to a method for fitting a fuel and/or oxidant injector, said injector having a tip that terminates in an injection opening.

According to this method, the injector is fitted into an assembly comprising a quarl block made of nonmetallic refractory material that has an entry face for a fuel and/or an oxidant and an exit face opposite the entry face. The quarl block defines a quarl exit that opens onto the exit face and a duct between the entry face and the quarl exit. The duct has a substantially annular or cylindrical output section with an inlet in or directed toward the entry face and, opposite the inlet, an outlet that opens into the quarl exit.

This assembly also includes a sheath comprising a substantially cylindrical sleeve having a downstream end, such that:

1) the output section of the duct surrounds the sleeve of the sheath;

2) the downstream end of the sleeve opens into the quarl exit; and

3) 0.4 mm≦Db−De≦1.0 mm.

According to the fitting method according to the invention, the injector is mounted in the duct of the quarl block so that the injector runs along the duct and opens into the quarl exit and the sleeve of the sheath surrounds the injector, at least in the output section of the duct, the injector and the sheath being such that:

1) there is a clearance ΔD of 0.2 mm to 0.4 mm between the sleeve of the sheath and the injector; and

2) 0.8×Linj≦Lf≦Linj and preferably 0.9×Linj≦Lf≦Linj.

Advantageously, the output section of the duct is substantially cylindrical.

The quarl block is typically made of refractory ceramic.

The injector is generally made of metal.

The length Lf of the sleeve of the sheath is advantageously equal to the length Linj of the injector.

To allow the tool thus obtained to operate, the injector is connected, depending on the case, to a fuel supply and/or to an oxidant supply.

The injector may in particular be fitted into the assembly comprising the quarl block and the sheath when the quarl block is already in a wall of a combustion chamber or of a furnace, such as a glass melting furnace, the exit face of the block then being directed toward the combustion chamber. More particularly, the block may be located in a wall of a glass conditioning feeder.

The fitting method thus relates in particular to replacing an injector present in a tool according to the invention already mounted in a wall of a furnace combustion chamber, for example in the context of furnace maintenance or for replacing a faulty injector. In this case, the pre-existing injector is firstly removed from the duct of the quarl block before a new injector is fitted. In practice, replacing the injector of the tool often takes place without the heating or melting process being interrupted. It is therefore important for the injector to be able to be fitted quickly and reliably and with the injector optimally centered in the quarl block.

When the internal surface of the substantially cylindrical sleeve of the sheath is provided with support/centering zones projecting between the sleeve and the injector, said support zones preferably cover less than 20%, preferably less than 15% and even more preferably less than 10% of the internal area of the sleeve.

Similarly, when the external surface of the injector is provided with projecting support/centering zones, these support zones advantageously cover less than 20%, preferably less than 15% and even more preferably less than 10% of the external area of the injector.

The support/centering zones usefully have a thickness d of 1.0 mm to 4.0 mm, preferably 2.0 mm to 3.0 mm.

The sleeve may be made of steel, refractory ceramic or refractory metal, preferably refractory steel.

As described above, the sheath may include anchoring elements.

Advantageously, the injector is made of a material such that 0.8×Cdf≦Cdinj≦1.05×Cdf, preferably 0.8×Cdf≦Cdinj≦Cdf and more preferably 0.90×Cdf≦Cdinj≦Cdf.

The tool, and especially the burner, according to the invention offers many advantages.

Firstly, the use of a sheath matched, on the one hand, to the geometry of the quarl block and in particular the geometry of its duct and, on the other hand, to the geometry of the injector makes it possible for most of the injector to be isolated from the atmosphere in the quarl exit. Since the sheath is not cooled by the fuel and/or oxidant flowing through the injector, its temperature is close to that of the block at the start of the quarl exit, and the phenomenon of material condensation on the injector, which is liable to hamper correct injection of the fluid or fluids, is significantly reduced or even eliminated. In general, it is unnecessary to provide any cooling means for the sheath.

Moreover, the presence of the sleeve around the injector also makes it possible to use the same injector type for quarl blocks having differently sized ducts. Only the outside diameter of the sleeve of the sheath will thus have to be varied in order to match the diameter of the duct of the quarl block in question. Given the low cost of the sheath compared to that of the injector, the fact of being able to standardize the injector enables the cost of the tool or burner to be significantly reduced.

Reducing or eliminating material deposits on the injector also has the advantage of making it easier to remove the injector from the tool. The reduction or even absence of deposits on the injector therefore reduces the risk of damaging the quarl block when removing or inserting the injector.

Moreover, the presence of the sheath minimizes friction between the injector and the quarl block during injector maintenance or replacement phases. Thus, the lifetime of the quarl block is extended.

In addition, and according to the invention, when the injector has to be replaced, the sheath can remain in the quarl block, so that the new injector is centered right from the first time it is fitted into the quarl block. This makes it possible to save a great deal of time and a fortiori to achieve a considerable financial advantage, especially in the case of glass conditioning, in which the number of tools or burners used on a conditioning feeder generally approaches several hundred.

In practice, the specific material of the sheath sleeve, which may be made of steel, refractory steel or refractory ceramic, is chosen so that the thermal expansion of the material of which the sheath sleeve is made, used at high temperature, is consistent and compatible, on the one hand, with the thermal expansion of the material of which the quarl block is made and, on the other hand, with the thermal expansion of the material of which the injector is made. Among refractory steels that can be used for manufacturing the sleeve, certain stainless steels and nickel-based materials, such as Inconel®, may in particular be noted.

The design rules established above make it possible:

to prevent seizing between the injector and the sheath sleeve;

to separate the two elements easily, for example to replace the injector;

to allow easy mounting of the sheath sleeve in the duct of the quarl block without damaging the latter and with the sleeve correctly centered in the duct;

to ensure that the injector is suitably centered in the sheath sleeve and therefore in the duct of the quarl block and consequently also to ensure that the flame is centered in the quarl exit, thus reducing the risk of damaging the quarl exit; and

to prevent excessively high mechanical stresses on the walls of the quarl block, which would consequently weaken or even damage the latter.

The present invention will be better understood in light of the examples described below, with reference to FIGS. 1 to 5, in which:

FIG. 1 is a schematic sectional view of a burner according to the prior art;

FIG. 2 is a schematic sectional view of a burner according the invention;

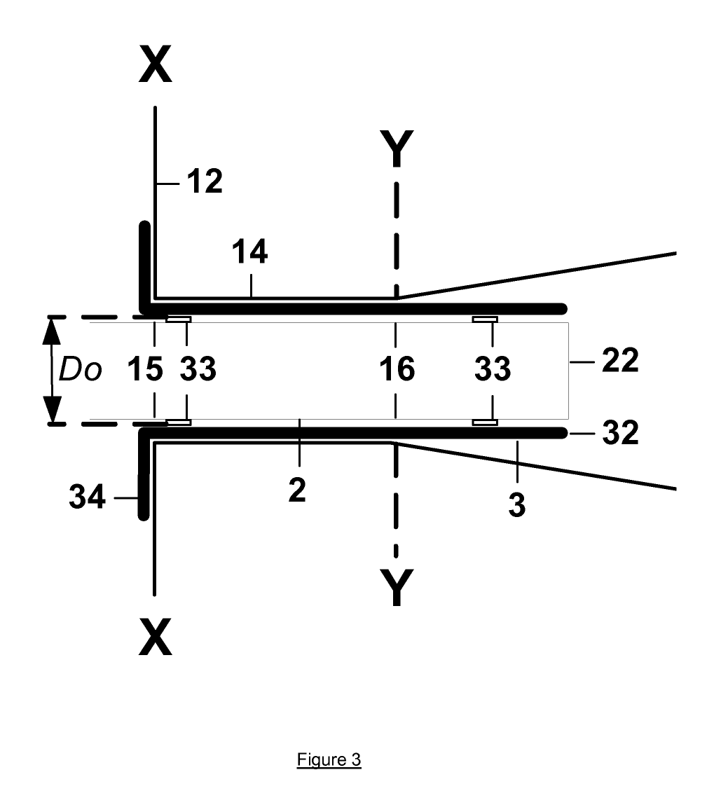

FIG. 3 is a schematic sectional view of a burner according to the invention with support/centering zones on the external surface of the injector; and

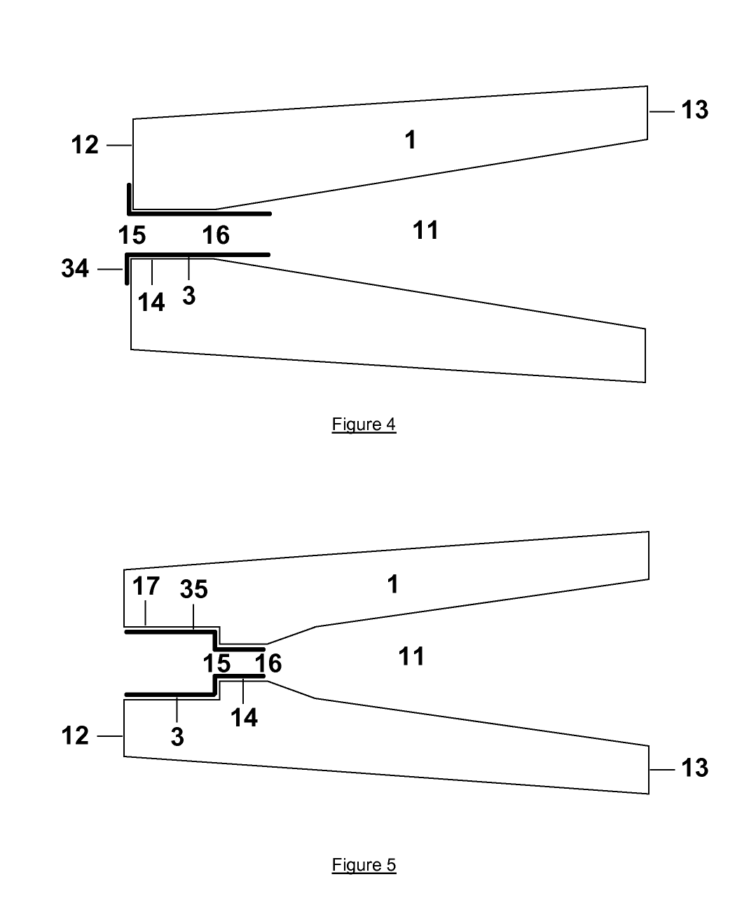

FIGS. 4 and 5 are schematic sectional views of two burners according to the invention provided with different anchoring elements (geometry A and geometry B).

FIG. 1 shows the effects of recirculation and condensation of deposits on the injector of a burner according to the prior art. It should be noted that not only do these deposits hamper correct injection of the fluid, especially at the risk of modifying the shape and the orientation of the flame, but they also make it difficult to replace the injector and may well damage the quarl block in the duct when replacing the injector.

The deposits on the injector may be reduced, or even eliminated, by using an oxidant or fuel injector or a burner according to the invention as illustrated in FIG. 2.

As shown in this figure, the quarl block 1 defines a quarl exit 11 that opens onto the exit face 13 (not shown in FIG. 2).

The quarl block also defines a duct between the entry face 12 of the quarl block and the quarl exit 11.

This duct comprises (and, in the case illustrated in FIG. 2, consists of) a substantially cylindrical output section 14 with an inlet 15 lying in the X-X plane and an outlet 16 lying in the Y-Y plane and opening into the quarl exit 11.

In FIG. 2, the inlet 15 of the output section 14 lies in the entry face 12 of the quarl block.

An oxidant and/or fuel injector 2 runs along the duct. The injector has a tip that terminates in an opening 22 for injecting the oxidant and/or fuel into the quarl exit 11.

The burner according to the invention also includes a sheath 3. The sheath comprises a substantially cylindrical sleeve 31 that surrounds the injector in the output section 14 of the duct. The downstream end 32 of the sheath 3, and therefore also that of the sleeve 31, opens into the quarl exit 11.

It should be noted that the sheath 3 surrounds the injector through which the fuel and/or the oxidant are conveyed and by means of which said fuel and/or said oxidant are injected into the quarl exit.

Db is the inside diameter of the output section 14 of the duct. De is the outside diameter of the substantially cylindrical sleeve 31 of the sheath. The difference between these two diameters ranges from 0.4 to 1.0 mm.

There is also a clearance between the substantially cylindrical sleeve 31 of the sheath and the injector, the sleeve having an inside diameter Di and the injector having an outside diameter Do at the sleeve 31.

This clearance, which in the case illustrated corresponds to Di−Do, ranges from 0.2 mm to 0.4 mm.

Lf is the length of the substantially cylindrical sleeve 31 of the sheath between the inlet 15 of the output section 14 of the duct and the downstream end 32 of the sheath. Similarly, Linj is the length of the injector between the inlet 15 of the output section 14 and the injection opening 22 of the injector.

In the embodiment illustrated in FIG. 2, Lf is slightly shorter than Linj.

During a heating process, the injector is cooled by the fluid (oxidant and/or fuel) that it injects. The sheath 3, which is not connected to a fuel and/or oxidant supply and does not serve to convey a fluid, is not subjected to such cooling. Consequently, the sleeve 31 of the sheath 3 is at a higher temperature than the injector, said sleeve 31, which surrounds the entire, or almost the entire, injector starting from the inlet 15 of the output section 14 of the duct, protecting the tip of the injector from deposits condensing thereon.

As illustrated in FIG. 3, it is generally useful to provide support/centering zones either on the internal surface of the sleeve 31 of the sheath 3 or on the external surface of the injector 2 at the sleeve 31, these support zones advantageously being on the external surface of the injector, as illustrated in FIG. 3.

FIG. 3 shows more particularly the preferred embodiment in which the support/centering zones 33 are projecting annular zones on the external surface of the injector 2. They cover only a small fraction of this surface.

The thickness d of said support/centering zones is between 1.0 mm and 4.0 mm, preferably between 2.0 and 3.0 mm. Thanks to these support/centering zones 33, direct contact between the cooler injector 2 and the hotter sleeve 31 is reduced and therefore the heat exchange therebetween is reduced.

Of course, the presence of such support/centering zones between the sleeve and the injector reduces the clearance ΔD between these two elements. Consequently, the thickness of said zones 33 does not form part of this clearance ΔD. If the clearance is expressed in terms of Di−Do, it is therefore necessary to consider as inside diameter Di of the sleeve the free inside diameter of the sleeve in said zones 33, if these are located on the internal surface of the sleeve, or, when, as in the case illustrated in FIG. 2, the zones 33 are on the external surface of the injector, it is necessary to consider as outside diameter of the injector the outside diameter of the injector in said zones, zones 33 included.

In the case illustrated in FIG. 3, it should be noted that the length Lf of the sleeve is equal to the length Linj of the injector.

FIGS. 3 and 4 show a system for anchoring a sheath 3 in a quarl block according to one embodiment in which the duct consists of a substantially cylindrical output section 14, the inlet of this output section being located in the entry face of the quarl block. Such an embodiment has what is called “geometry A”.

More particularly, the sheath 3 includes a flange 34 which presses against the entry face of the quarl block, so as to hold the sheath in place on this side of the quarl block, and to make it impossible for the sheath to become detached and to slip toward the quarl exit or even into the combustion chamber.

FIG. 5 shows another system for anchoring the sheath 3 in a quarl block according to an embodiment in which the duct includes a second section 17 upstream of the output section 14 and having a larger diameter than the output section 14. Such an embodiment has what is called “geometry B”.

The sheath 3 is anchored in that it includes a part 35, located upstream of the sleeve 31, which is fitted into the section 17 of the duct. Because this part 35 has a larger outside diameter than the inside diameter of the output section of the duct, the position of the sheath is fixed in relation to the inlet of the output section of the duct, so that the sheath cannot become detached and slip toward the quarl exit or into the combustion chamber.

The relevance of the materials and dimensions was confirmed experimentally in pilot and industrial trials lasting more than ten months.

The dimensions of the burner used were:

diameter D of the injection opening of the injector: 16 mm;

outside diameter Do of the injector at the sleeve: 19 mm;

support/centering zones: two stainless-steel annular zones of the same, constant thickness over the entire circumference of the injector;

inside diameter Di of the sheath sleeve: 19.3 mm;

outside diameter De of the sleeve: 25.5 mm;

inside diameter Db of the output section of the duct: 26.1 mm; and

length Lf of the sheath sleeve=length Linj of the injector (starting from the inlet of the output section of the duct): 65 mm.

The materials used were:

for the entire sheath (including the sleeve): Inconel;

for the injector: stainless steel; and

for the quarl block (in geometry A): AZS (alumina-zirconia-silica).

The industrial trials were carried out in a conditioning feeder for the production of reinforcing glass fibers and demonstrated the relevance of the invention explained herein.

This is because, after burners with no protective sheath had been used for several weeks, it was found that there was a relatively large amount of material deposited on the injectors, requiring said injectors to be cleaned. In contrast, the addition of a sheath around the injector, in accordance with the present invention, allowed the same injectors to be used, in the same industrial configuration, for several months without this phenomenon reappearing.

Although the above examples relate to burners according to the invention, it is obvious that the various aspects of the invention described above apply equally to tools according to the invention other than burners.

1-15. (canceled)

16. A combustion tool comprising:
a quarl block made of nonmetallic refractory material having an entry face for a fuel and/or an oxidant and an exit face opposite the entry face, said quarl block defining a quarl exit that opens into the exit face, and a duct between the entry face and the quarl exit, said duct having:
a substantially annular or cylindrical output section with an inlet in or directed toward the entry face, and
opposite the inlet, an outlet that opens into the quarl exit;
an injector for conveying fuel and/or oxidant from the entry face of the block toward the quarl exit, said injector passing through the duct and having a tip that terminates in an injection opening that opens into the quarl exit; and
a sheath comprising a substantially cylindrical sleeve that surrounds the injector in the output section of the duct and has a downstream end that opens into the quarl exit, such that:
0.4 mm≦Db−De≦1.0 mm, Db being the inside diameter of the output section of the duct and De being the outside diameter of the sleeve of the sheath;
there is a clearance ΔD of 0.2 mm to 0.4 mm between the sleeve of the sheath and the injector; and
0.8×Linj≦Lf≦Linj, Lf being the length of the sleeve of the sheath between the inlet of the outlet section of the duct and the downstream end of the sheath, Linj being the length of the injector between the inlet of the output section of the duct and the injection opening of the injector, preferably 0.9×Linj≦Lf≦Linj.

17. The tool of claim 16, wherein an internal surface of the sleeve is provided with support/centering zones projecting between the sleeve and the injector, said support/centering zones covering less than 20% of the surface area of the internal surface of the sleeve.

18. The tool of claim 16, wherein an external surface of the injector is provided with support/centering zones projecting between the injector and the sleeve, said support/centering zones covering less than 20% of the external area of the injector.

19. The tool of claim 16, wherein the sleeve of the sheath is made of refractory ceramic or refractory metal.

20. The tool of claim 16, wherein the sheath includes anchoring means fixing a position of the sheath relative to the inlet of the outlet section of the duct.

21. A melting furnace having walls around a combustion chamber and the tool of claim 16 mounted in at least one of said walls in such a way that the quarl exit opens into the combustion chamber.

22. The melting furnace of claim 21, said furnace being a glass melting furnace or a glass conditioning feeder.

23. A method for assembling a tool comprising the steps of:
providing a fuel and/or oxidant injector having a tip that terminates in an injection opening;
providing a quarl block made of nonmetallic refractory material having an entry face for a fuel and/or an oxidant and an exit face opposite the entry face, said quarl block defining a quarl exit that opens onto the exit face, and a duct between the entry face and the quarl exit, said duct having a substantially annular or cylindrical output section with an inlet in or directed toward the entry face and, opposite the inlet, an outlet that opens into the quarl exit, the output section of the duct having an inside diameter Db;
providing a sheath comprising a substantially cylindrical sleeve having a downstream end, the sleeve of the sheath having an outside diameter De;
fitting the sheath into the duct so that the sleeve enters the output section of the duct and the downstream end opens into the quarl exit; and
fitting the injector into the duct so that the injector passes through the duct and opens into the quarl exit and so that the sleeve of the sheath surrounds the injector in the output section of the duct, such that:
0.4 mm≦Db−De≦1.0 mm;
there a clearance ΔD of 0.2 mm to 0.4 mm between the sleeve of the sheath and the injector; and
0.8×Linj≦Lf≦Linj, Lf being a length of the sleeve of the sheath between the inlet of the outlet section of the duct and the downstream end of the sheath, Linj being a length of the injector between the inlet of the output section of the duct and the injection opening of the injector, preferably 0.9×Linj≦Lf≦Linj.

24. A method for fitting a fuel and/or oxidant injector into an assembly, comprising the steps of:
a) providing an injector having a tip that terminates in an injection opening;
b) providing an assembly comprising:
a quarl block made of nonmetallic refractory material having an entry face for a fuel and an oxidant and an exit face opposite the entry face, the quarl block defining a quarl exit that opens onto the exit face, and a duct between the entry face and the quarl exit, said duct having a substantially annular or cylindrical output section with an inlet in or directed toward the entry face and, opposite the inlet, an outlet that opens into the quarl exit; and
a sheath comprising a substantially cylindrical sleeve having a downstream end, such that:
the output section of the duct surrounds the sleeve of the sheath;
the downstream end of the sleeve opens into the quarl exit; and
0.4 mm≦Db−De≦1.0 mm, Db being the inside diameter of the output section of the duct and De being the outside diameter of the sleeve of the sheath; and
c) fitting an injector into the duct of the quarl block so that the injector passes through the duct and opens into the quarl exit and the sleeve of the sheath surrounds the injector, at least in the output section of the duct, wherein:
there is a clearance ΔD of 0.2 mm to 0.4 mm between the sleeve of the sheath and the injector; and
0.8×Linj≦Lf≦Linj, Lf being the length of the sleeve of the sheath between the inlet of the output section of the duct and the downstream end of the sheath, Linj being the length of the injector between inlet of the output section of the duct and the injection opening of the injector, preferably 0.9×Linj≦Lf≦Linj.

25. The method of claim 23, wherein the injector is connected to a fuel supply and/or to an oxidant supply.

26. The method of claim 23, wherein the quarl block is located in a wall of a combustion chamber.

27. The method of claim 23, wherein an internal surface of the sleeve is provided with support/centering zones projecting between the sleeve and the injector, said support/centering zones covering less than 20% of the surface area of the internal surface of the sleeve.

28. The method of claim 23, wherein an external surface of the injector is provided with support/centering zones projecting between the injector and the sleeve, said support/centering zones covering less than 20% of the surface area of the internal surface of the injector.

29. The method of claim 23, wherein the sleeve of the sheath is made of refractory ceramic or refractory metal.

30. The method of claim 23, wherein the sheath includes anchoring means for fixing the position of the sheath relative to the inlet of the output section of the duct.

31. The tool of claim 17, wherein said support/centering zones cover less than 15% of the internal area of the substantially cylindrical sleeve.

32. The tool of claim 17, wherein said support/centering zones cover less than 10% of the internal area of the substantially cylindrical sleeve.

33. The tool of claim 17, wherein said support/centering zones have a thickness d of 1.0 mm to 2.0 mm.

34. The tool of claim 18, wherein said support/centering zones cover less than 15% of the external area of the injector.

35. The tool of claim 18, wherein said support/centering zones covering less than 10% of the external area of the injector.

36. The tool of claim 18, wherein said support/centering zones have a thickness d of 1.0 mm to 2.0 mm.

37. The tool of claim 16, wherein the sleeve of the sheath is made of refractory ceramic or refractory metal, preferably refractory steel.

38. The method of claim 23, wherein 0.9×Linj≦Lf≦Linj.

39. The method of claim 26, wherein the combustion chamber is a glass melting furnace or a glass conditioning feeder.

40. The method of claim 27, wherein said support/centering zones cover less than 15% of the surface area of the internal surface of the sleeve.

41. The method of claim 27, wherein said support/centering zones cover less than 10% of the surface area of the internal surface of the sleeve.

42. The method of claim 27, wherein said support/centering zones have a thickness d of 1.0 mm to 2.0 mm.

43. The method of claim 28, wherein said support/centering zones cover less than 15% of the surface area of the internal surface of the injector.

44. The method of claim 28, wherein said support/centering zones cover less than 10% of the surface area of the internal surface of the injector.

45. The method of claim 28, wherein said support/centering zones have a thickness d of 1.0 mm to 2.0 mm.

46. The method of claim 23, wherein the sleeve of the sheath is made of refractory steel.
